(19) United States
(12) Patent Application Publication
(10) Pub. No.: US 2013/0230680 A1
(43) Pub. Date: Sep. 5, 2013

(54) PROTECTIVE FILM FOR A PORTABLE ELECTRONIC DEVICE

(71) Applicant: Shen-Hsin CHENG, Tianzhong Township (TW)

(72) Inventor: Shen-Hsin CHENG, Tianzhong Township (TW)

(21) Appl. No.: 13/759,388

(22) Filed: Feb. 5, 2013

(30) Foreign Application Priority Data
Mar. 2, 2012 (TW) 101203719

(51) Int. Cl. B32B 7/06

(52) U.S. Cl. CPC B32B 7/06
USPC 428/41.7

(57) ABSTRACT

A protective film has a protective layer, a figure layer, an acrylic resin layer, a substrate, a silicon gel layer and a releasing sheet. The protective layer is pervious to light. The figure layer is attached to the protective layer. The acrylic resin layer is attached to the figure layer to securely hold the figure layer on the protective layer. The substrate is pervious to light and is attached to the acrylic resin layer. The silicon gel layer is attached to the substrate. The releasing sheet is attached to the silicon gel layer. The protective layer further has a window segment and a non-window segment. The figure layer has a shape same as the shape of the non-window segment and corresponds to the non-window segment in position.

### BACKGROUND OF THE INVENTION

1. Field of the Invention

The present invention relates to a protective film, and more particularly to a protective film for a portable electronic device.

2. Description of Related Art

To protective a screen or a case of a portable electronic device, such as a cell phone or a panel computer, a protective film is attached to the portable electronic device such that the screen or the case of the electronic device can be kept from being scraped. In addition, the conventional protective film may be provided with a figure layer to improve the aesthetic appearance of the portable electronic device onto which the protective film is attached.

However, the figure layer of the conventional protective film is formed on an outer surface of the protective film and is easily worn off or fades.

To overcome the shortcomings, the present invention tends to provide a protective film to mitigate or obviate the aforementioned problems.

### SUMMARY OF THE INVENTION

The main objective of the invention is to provide a protective film for a portable electronic device to keep a figure layer from being worn off or fading.

The protective film has a protective layer, a figure layer, an acrylic resin layer, a substrate, a silicon gel layer and a releasing sheet. The protective layer is pervious to light and has a bottom. The figure layer is attached to the bottom of the protective layer and has a bottom opposite to the bottom of the protective layer. The acrylic resin layer is attached to the bottom of the figure layer and has a bottom opposite to the bottom of the figure layer. The substrate is pervious to light, is attached to the bottom of the acrylic resin layer and has a bottom opposite to the bottom of the acrylic resin layer. The silicon gel layer is attached to the bottom of the substrate and has a bottom opposite to the bottom of the substrate. The releasing sheet is attached to the bottom of the silicon gel layer. The protective layer has a window segment and a non-window segment that has a shape. The figure layer has a shape same as the shape of the non-window segment and corresponds to the non-window segment in position. The acrylic resin layer is attached to the bottom of the figure layer and the bottom of the protective layer at a position corresponding to the window segment.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a protective film in accordance with the present invention;

FIG. 2 is a perspective view of a second embodiment of a protective film in accordance with the present invention;

FIG. 3 is an enlarged cross sectional side view of the protective film in FIG. 1;

FIG. 4 shows operational cross sectional side view of the protective film in FIG. 1;

FIG. 5 is a perspective view of the protective film in FIG. 1 attached onto a portable electronic device; and

FIG. 6 is a perspective view of the protective film in FIG. 2 attached onto a portable electronic device.

### DETAILED DESCRIPTION OF PREFERRED EMBODIMENT

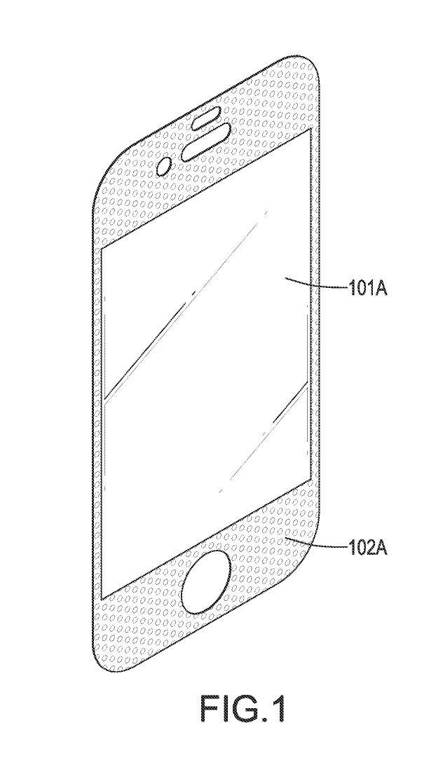

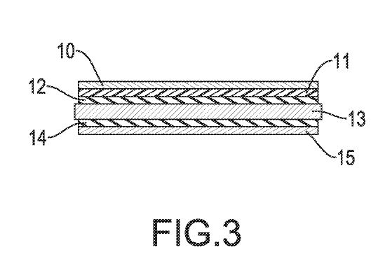

With reference to FIGS. 1 to 3, a protective film in accordance with the present invention can be attached to a screen or case of a portable electronic device, such as a cell phone or a panel computer and comprises a protective layer 10, a figure layer 11, an acrylic resin layer 12, a substrate 13, a silicon gel layer 14 and a releasing sheet 15.

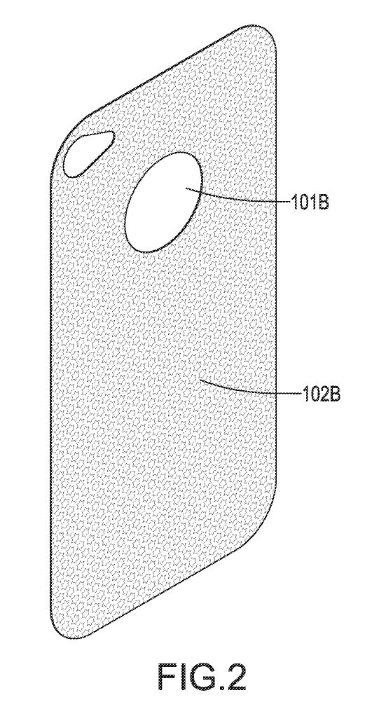

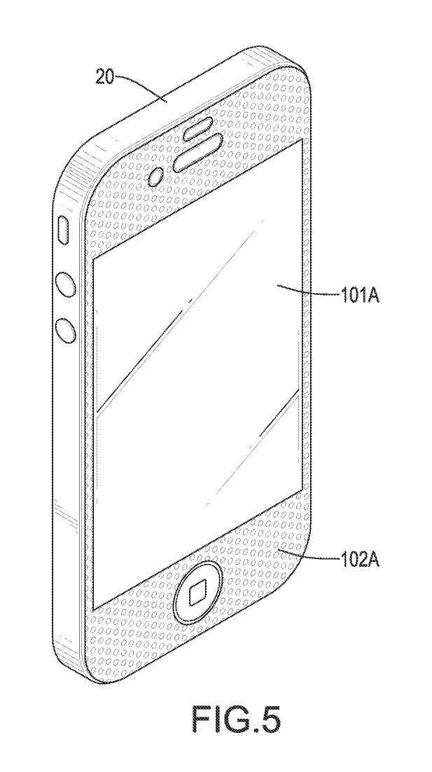

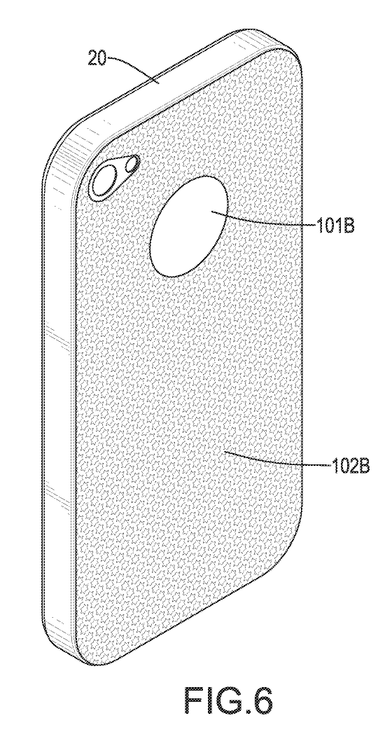

The protective layer 10 is pervious to light, may be made of polyethylene terephthalate (PET), polyethylene (PE) or thermoplastic elastomer (TPE) and has a bottom. The protective layer 10 has a window segment 101A,101B and a non-window segment 102A,102B that has a shape. The window segment 101A,101B is formed on the protective layer 10 at position corresponding to the screen, figure or trademark on the electronic device 20. In the first embodiment as shown in FIGS. 1 and 5, the window segment 101A is rectangular, is formed on a central segment of the protective layer 10 and has a size and a shape corresponding to those of a screen of a cell phone. In the second embodiment as shown in FIGS. 2 and 6, the window segment 101B is circular and has a position, a size and a shape corresponding to those of a trademark of a cell phone. The non-window segment 102A,102B is formed on the protective layer 10 at a position beside the window segment 101A,101B.

The figure layer 11 is attached to the bottom of the protective layer 10 and has a shape and a bottom opposite to the bottom of the protective layer 10. The shape of the figure layer 11 is same as the shape of the non-window segment 102A,102B and corresponds to the non-window segment 102A,102B in position.

The acrylic resin layer 12 is attached to the bottom of the figure layer 11 to securely hold the figure layer 11 on the bottom of the protective layer 10 and has a bottom opposite to the bottom of the figure layer 11. With the arrangement of the shapes of the figure layer 11 and the window segment 101A,101B, the acrylic resin layer 12 is attached to the bottom of the figure layer 11 and the bottom of the protective layer 10 at a position corresponding to the window segment 101A,101B.

The substrate 13 is pervious to light, is attached to the bottom of the acrylic resin layer 12 and has a bottom opposite to the bottom of the acrylic resin layer 12. Preferably, the substrate 13 is made of polyethylene terephthalate (PET) or polyethylene (PE).

The silicon gel layer 14 is attached to the bottom of the substrate 13 and has a bottom opposite to the bottom of the substrate 13. The releasing sheet 15 is attached to the bottom of the silicon gel layer 14.

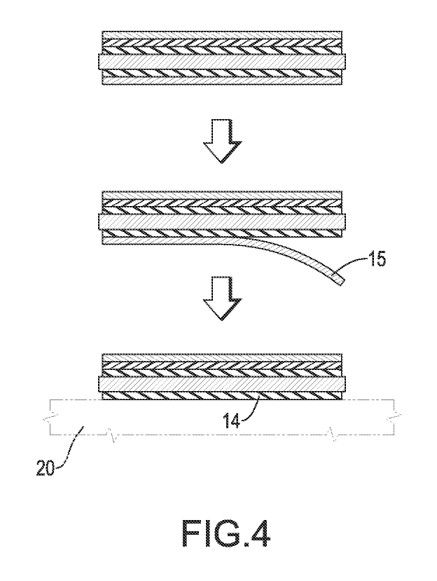

With reference to FIGS. 4 to 6, in use, the releasing sheet 15 is detached from the silicon gel layer 14, and the protective film can be securely attached to a screen or a case of a portable electronic device 20 by the silicon gel layer 14. Accordingly, the screen or the case of the electronic device 20 can be kept from scraped. In addition, because the figurer layer 11 is mounted between the protective layer 10 and the acrylic resin layer 12, the figurer layer 11 will not be worn off or fade even after a long term of use.

Furthermore, with the arrangement of the window segment 101A,101B, the screen or the trademark of the electronic device 20 is visible via the window segment 101A,101B and is not blocked by the figure layer 11.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A protective film comprising:
a protective layer being pervious to light and having a bottom;
a figure layer attached to the bottom of the protective layer and having a bottom opposite to the bottom of the protective layer;
an acrylic resin layer attached to the bottom of the figure layer and having a bottom opposite to the bottom of the figure layer;
a substrate being pervious to light, attached to the bottom of the acrylic resin layer and having a bottom opposite to the bottom of the acrylic resin layer;
a silicon gel layer attached to the bottom of the substrate and having a bottom opposite to the bottom of the substrate; and
a releasing sheet attached to the bottom of the silicon gel layer, wherein
the protective layer comprises a window segment and a non-window segment that has a shape;
the figure layer has a shape same as the shape of the non-window segment and corresponds to the non-window segment in position; and
the acrylic resin layer is attached to the bottom of the figure layer and the bottom of the protective layer at a position corresponding to the window segment.
